(19) United States
(12) Patent Application Publication
(10) Pub. No.: US 2026/0248326 A1
(43) Pub. Date: Aug. 27, 2026

(54) VIBRATING COOKING SPATULA

(71) Applicant: Dongguan Shengtu Technology Co., Ltd., Dongguan (CN)

(72) Inventors: YanHua Deng, Dongguan (CN); QuanFeng Li, Dongguan (CN)

(21) Appl. No.: 19/647,714

(22) Filed: Apr. 14, 2026

(30) Foreign Application Priority Data
Mar. 27, 2026 (CN) 2026203965599

(51) Int. Cl. A47J 43/28

(52) U.S. Cl. CPC A47J 43/288

(57) ABSTRACT

A vibrating cooking spatula comprises a handle, a spatula body, a circuit board, a battery, a control switch, and a vibrating device. The vibrating device disposed at the front end of the handle drives the spatula body to vibrate, and may be a vibrating motor and/or an ultrasonic transducer. The vibration facilitates full integration of soup and seasonings with food, uniform flavoring, easy detachment of food from the pot bottom, and less manual stir-frying effort. All electronic components are integrated inside the handle for good practicability and structural stability, thereby improving cooking taste and operating experience.

### TECHNICAL FIELD

The present discloses relates to the technical field of kitchen utensils, and more particularly, to a vibrating cooking spatula.

### BACKGROUND ART

In the field of kitchen utensil cooking, the cooking spatula, as a core tool for stir-frying, mixing, and scooping food materials, is widely used in daily cooking scenarios. A conventional ordinary cooking spatula is structurally designed with only an integrated handle and spatula body, which can only achieve basic mechanical operation functions and is completely devoid of a vibration-assisted cooking design. In actual use, it has many obvious defects.

During stir-frying, food materials tend to stick to the pot bottom and are difficult to separate; seasonings, soups, and other liquid condiments cannot fully integrate with the food materials. Users have to rely solely on manual repeated waving of the cooking spatula for stir-frying, which not only requires continuous force exertion and consumes a great deal of physical strength, making the cooking process cumbersome and laborious, but also the manual stir-frying method fails to easily separate food materials stuck to the pot bottom and cannot allow liquid condiments to combine with food materials completely and uniformly. Condiments can only adhere to the surface of food materials and cannot penetrate into the interior of food materials, which is very likely to cause uneven flavoring and local bland taste, seriously affecting the overall taste and deliciousness of dishes.

Especially when cooking dishes requiring sauce coating, thick sauce tends to accumulate and clump on an ordinary cooking spatula and cannot disperse quickly, further reducing cooking efficiency and making it difficult to achieve ideal dish-making effects. With the continuous improvement of people's requirements for cooking experience and dish taste, the conventional non-vibrating ordinary cooking spatula can no longer meet the daily cooking needs of high efficiency, convenience, and deliciousness. There is an urgent need for a cooking spatula with a vibration-assisted function to make up for the shortcomings of the prior art.

### SUMMARY

In view of the above deficiencies in the prior art, the primary object of the present discloses is to provide a vibrating cooking spatula, which can effectively solve the problems that a conventional cooking spatula cannot easily separate food materials stuck to the pot bottom, cannot efficiently introduce liquid condiments into the interior of food materials, and causes uneven flavoring of food materials.

To achieve the above object, the present discloses adopts the following technical solutions:

A vibrating cooking spatula comprises a handle and a spatula body; the spatula body is disposed at a front end of the handle; the vibrating cooking spatula further comprises a circuit board, a battery, a control switch, and a vibrating device; the circuit board, the battery, and the control switch are all disposed on the handle; the battery and the control switch are both electrically connected to the circuit board; the vibrating device is located at the front end of the handle and drives the spatula body to vibrate; the vibrating device is electrically connected to the circuit board.

Preferably, the vibrating device is a vibrating motor and/or an ultrasonic transducer; the vibrating motor is fixed to a rear end of the spatula body, and the ultrasonic transducer is fixed to a rear end surface of the spatula body.

Preferably, the vibrating motor and/or the ultrasonic transducer are/is both located inside the front end of the handle.

Preferably, a receiving groove is formed at the rear end of the spatula body; the vibrating motor is located in the receiving groove, and the vibrating motor is clamped and fixed to the rear end of the spatula body by an upper clamping base and a lower clamping base in cooperation.

Preferably, the ultrasonic transducers are grouped in 1 to 4 pieces, and the ultrasonic transducers are respectively attached and fixed to upper and lower surfaces of the rear end of the spatula body.

Preferably, the handle comprises an upper shell and a lower shell; the upper shell and the lower shell are assembled vertically to define a receiving cavity; the circuit board, the battery, the control switch, and the vibrating device are all located in the receiving cavity.

Preferably, the control switch is disposed on the circuit board and exposed out of an outer surface of the upper shell.

Preferably, a through hole is formed in a middle portion of the upper shell; the control switch is a push-type control switch or a touch-type switch; the control switch is provided with a key cap or a touch switch mark; the key cap passes through the through hole from inside to outside and is exposed out of the outer surface of the upper shell.

Compared with the prior art, the present discloses has obvious advantages and beneficial effects. Specifically, as can be known from the above technical solutions:

By additionally arranging the electrically connected circuit board, battery, control switch, and vibrating device on the cooking spatula, the spatula body is provided with a vibrating function, which solves the problems that a conventional cooking spatula cannot fully integrate soup with food materials, causes uneven flavoring of food materials, and fails to separate food materials stuck to the pot bottom. Meanwhile, it reduces the physical consumption of manual stir-frying and makes cooking operations easier. Through a reasonable structural design, all electronic components are integrated inside the handle, ensuring the overall practicability and structural stability of the cooking spatula, and achieving the purposes of improving the cooking taste of dishes and optimizing the cooking operation experience.

### BRIEF DESCRIPTION OF THE DRAWINGS

FIG. 1 is an assembled perspective view of a preferred embodiment of the present discloses;

FIG. 2 is another assembled perspective view of the preferred embodiment of the present discloses;

FIG. 3 is an exploded view of the preferred embodiment of the present discloses;

FIG. 4 is another exploded view of the preferred embodiment of the present discloses;

FIG. 5 is a cross-sectional view of the preferred embodiment of the present discloses.

Reference numerals in the drawings:

10. Handle 11. Upper shell

12. Lower shell 101. Receiving cavity

102. Through hole 20. Spatula body

21. Receiving groove 30. Circuit board

31. Battery charging port 40. Battery

50. Control switch 51. Key cap

60. Vibrating device 61. Vibrating motor

62. Ultrasonic transducer 63. Upper clamping base

64. Lower clamping base

### DETAILED DESCRIPTION OF THE EMBODIMENTS

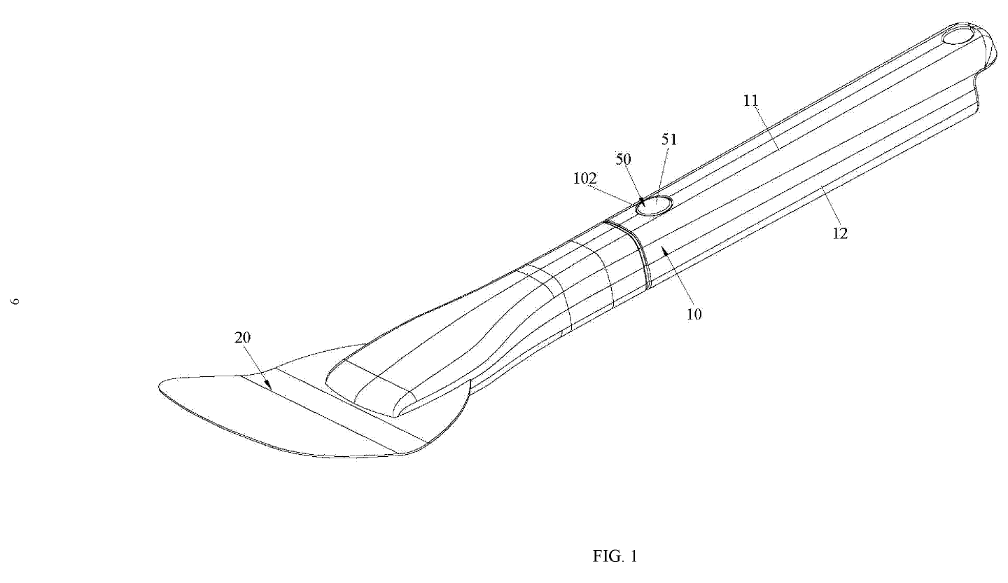

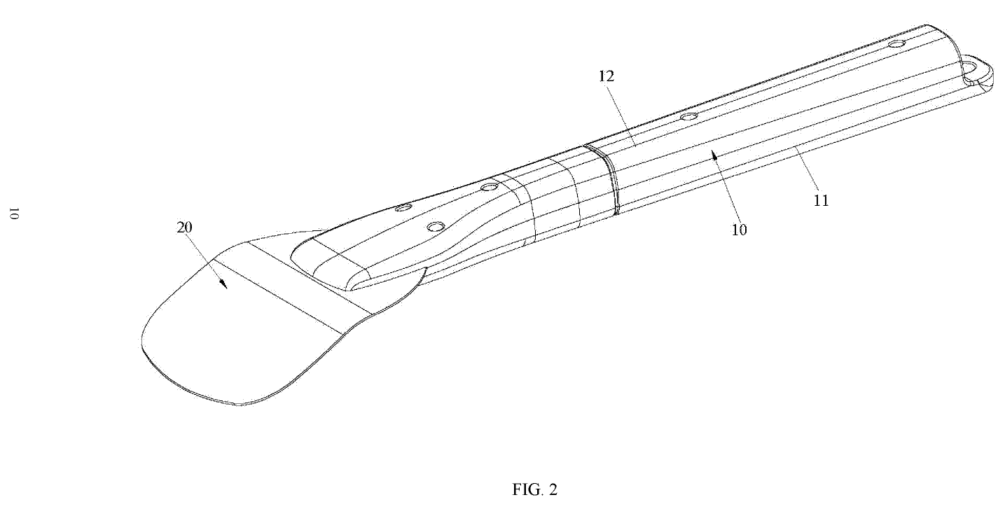

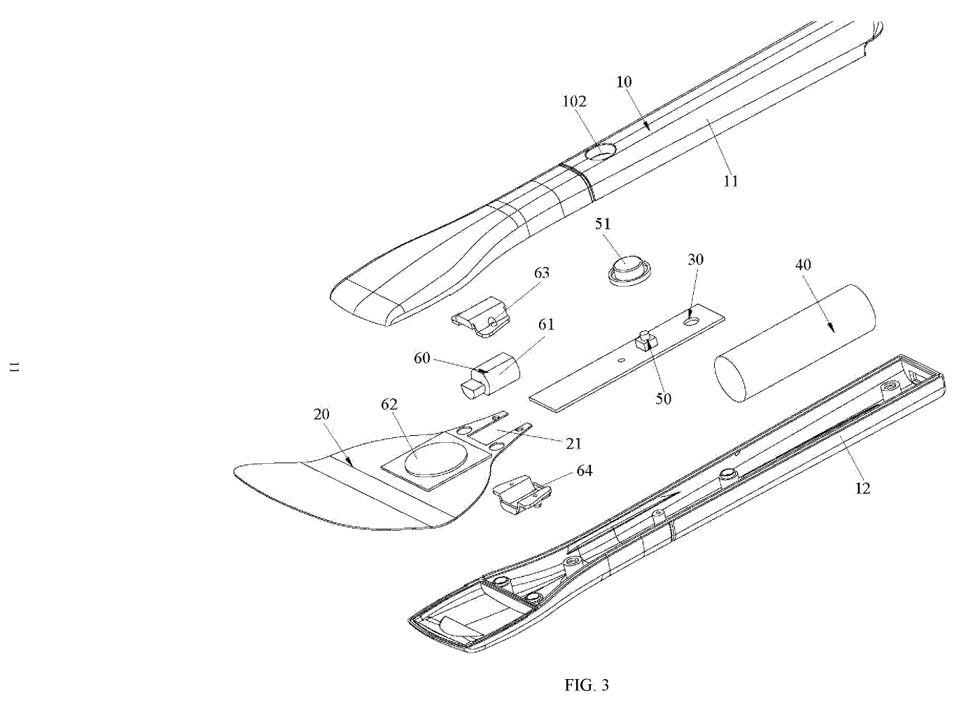

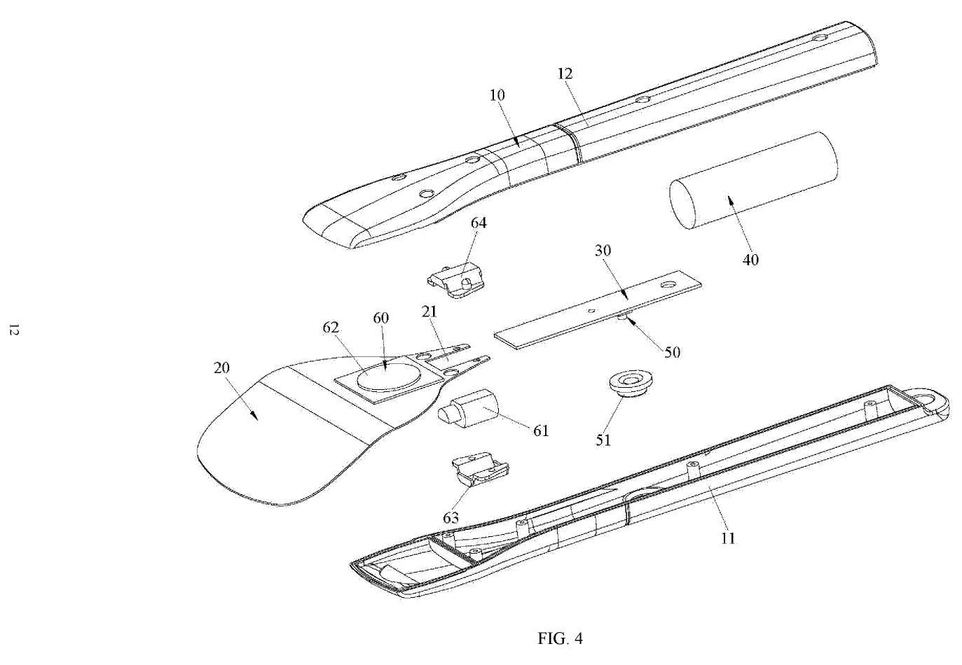

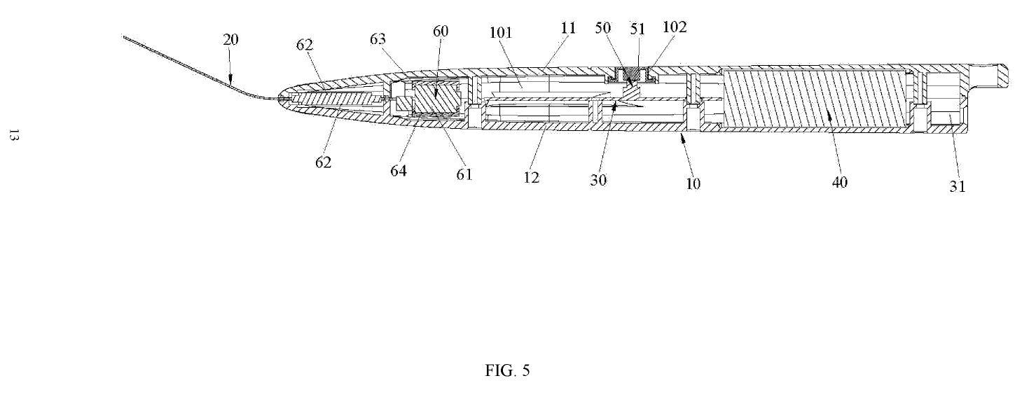

Referring to FIGS. 1 to 5, a specific structure of a preferred embodiment of the present discloses is shown, comprising a handle 10, a spatula body 20, a circuit board 30, a battery 40, a control switch 50, and a vibrating device 60.

The handle 10 comprises an upper shell 11 and a lower shell 12; the upper shell 11 and the lower shell 12 are assembled vertically to define a receiving cavity 101; the upper shell 11 and the lower shell 12 may be fixedly connected by fasteners such as screws, but not limited thereto. A through hole 102 is formed in a middle portion of the upper shell 11, and the through hole 102 is communicated with the receiving cavity 101.

The spatula body 20 is disposed at a front end of the handle 10. In this embodiment, a rear end of the spatula body 20 is clamped and fixed by a front end of the upper shell 11 and a front end of the lower shell 12 in cooperation; a receiving groove 21 is formed at the rear end of the spatula body 20.

The circuit board 30, the battery 40, and the control switch 50 are all disposed on the handle 10; the battery 40 and the control switch 50 are both electrically connected to the circuit board 30. In this embodiment, the circuit board 30, the battery 40, and the control switch 50 are all located in the receiving cavity 101; the battery 40 is a rechargeable battery and is located behind the circuit board 30; the control switch 50 is disposed on the circuit board 30 and exposed out of an outer surface of the upper shell 11. Furthermore, the control switch 50 is a push-type or touch-type control switch; the control switch 50 is provided with a key cap 51 or a touch switch mark; the key cap 51 passes through the through hole 102 from inside to outside and is exposed out of the outer surface of the upper shell 11. In addition, a battery charging port 31 is disposed on the handle 10; the battery charging port 31 is electrically connected to the circuit board 30 so as to charge the battery 40; the battery charging port 31 is located at a rear end of the handle 10, but not limited thereto.

The vibrating device 60 is located at the front end of the handle 10 and drives the spatula body 20 to vibrate; the vibrating device 60 is electrically connected to the circuit board 30. The vibrating device 60 is located in the receiving cavity 101; the vibrating device 60 is a vibrating motor 61 and/or an ultrasonic transducer 62; the vibrating motor 61 is fixed to the rear end of the spatula body 20, and the ultrasonic transducer 62 is fixed to the rear end surface of the spatula body 20. In this embodiment, the vibrating device 60 is composed of the vibrating motor 61 and the ultrasonic transducer 62 to produce a better vibrating effect; certainly, it may also be provided with only the vibrating motor 61 or only the ultrasonic transducer 62, but not limited thereto. Furthermore, the vibrating motor 61 and the ultrasonic transducer 62 are both located inside the front end of the handle 10; the vibrating motor 61 is located in the receiving groove 21, and the vibrating motor 61 is clamped and fixed to the rear end of the spatula body 20 by an upper clamping base 63 and a lower clamping base 64 in cooperation. The ultrasonic transducers 62 are grouped in 1 to 4 pieces, and two ultrasonic transducers 62 are respectively attached and fixed to upper and lower surfaces of the rear end of the spatula body 20.

The use method of this embodiment is detailed as follows:

In use, when the control switch 50 is operated to turn on the product, the battery 40 supplies power to the circuit board 30; then, the circuit board 30 controls the vibrating motor 61 and the ultrasonic transducer 62 to work. The vibrating motor 61 converts electric energy into mechanical energy to generate low-frequency vibration, and the ultrasonic transducer 62 converts electric energy into mechanical energy to generate high-frequency vibration. Such high-low frequency combined vibration makes the spatula body 20 vibrate, which can atomize liquid on the product, so that liquid condiments are uniformly distributed on food materials. Through high-low frequency mixed vibration, condiments are efficiently introduced into the interior of food materials. Meanwhile, the vibration solves the problem of separation when food materials stick to the pot bottom due to high temperature during stir-frying. Stir-frying with the product can make food materials more delicious, more flavorful, and better in taste, and stir-frying is easier.

The key design point of the present discloses is:

By additionally arranging the electrically connected circuit board, battery, control switch, and vibrating device on the cooking spatula, the spatula body is provided with a vibrating function, which solves the problems that a conventional cooking spatula cannot fully integrate soup with food materials, causes uneven flavoring of food materials, and fails to separate food materials stuck to the pot bottom. Meanwhile, it reduces the physical consumption of manual stir-frying and makes cooking operations easier. Through a reasonable structural design, all electronic components are integrated inside the handle, ensuring the overall practicability and structural stability of the cooking spatula, and achieving the purposes of improving the cooking taste of dishes and optimizing the cooking operation experience.

The technical principles of the present discloses have been described above with reference to specific embodiments. These descriptions are only for explaining the principles of the present discloses and shall not be construed as limiting the scope of protection of the present discloses in any way. Based on the explanations herein, those skilled in the art can think of other specific embodiments of the present discloses without creative efforts, and these embodiments shall all fall within the scope of protection of the present discloses.

1. A vibrating cooking spatula, comprising a handle and a spatula body; the spatula body is disposed at a front end of the handle; wherein the vibrating cooking spatula further comprises a circuit board, a battery, a control switch, and a vibrating device; the circuit board, the battery, and the control switch are all disposed on the handle; the battery and the control switch are both electrically connected to the circuit board; the vibrating device is located at the front end of the handle and drives the spatula body to vibrate; the vibrating device is electrically connected to the circuit board.

2. The vibrating cooking spatula according to claim 1, wherein the vibrating device is a vibrating motor and/or an ultrasonic transducer; the vibrating motor is fixed to a rear end of the spatula body, and the ultrasonic transducer is fixed to a rear end surface of the spatula body.

3. The vibrating cooking spatula according to claim 2, wherein the vibrating motor and/or the ultrasonic transducer are/is both located inside the front end of the handle.

4. The vibrating cooking spatula according to claim 2, wherein a receiving groove is formed at the rear end of the spatula body; the vibrating motor is located in the receiving groove, and the vibrating motor is clamped and fixed to the rear end of the spatula body by an upper clamping base and a lower clamping base in cooperation.

5. The vibrating cooking spatula according to claim 2, wherein the ultrasonic transducers are grouped in 1 to 4 pieces, and the ultrasonic transducers are respectively attached and fixed to upper and lower surfaces of the rear end of the spatula body.

6. The vibrating cooking spatula according to claim 1, wherein the handle comprises an upper shell and a lower shell; the upper shell and the lower shell are assembled vertically to define a receiving cavity; the circuit board, the battery, the control switch, and the vibrating device are all located in the receiving cavity.

7. The vibrating cooking spatula according to claim 6, wherein the control switch is disposed on the circuit board and exposed out of an outer surface of the upper shell.

8. The vibrating cooking spatula according to claim 6, wherein a through hole is formed in a middle portion of the upper shell; the control switch is a push-type control switch or a touch-type switch; the control switch is provided with a key cap or a touch switch mark; the key cap passes through the through hole from inside to outside and is exposed out of the outer surface of the upper shell.
